(19) United States
(12) Patent Application Publication
(10) Pub. No.: US 2024/0169250 A1
(43) Pub. Date: May 23, 2024

(54) Method, System and Software to Eliminate Learned Information from a Trained Machine Learning Model

(71) Applicant: Robert Kern Sears, Santa Rosa, CA (US)

(72) Inventor: Robert Kern Sears, Santa Rosa, CA (US)

(21) Appl. No.: 17/989,691

(22) Filed: Nov. 18, 2022

(51) Int. Cl. G06N 20/00

(52) U.S. Cl. CPC G06N 20/00

(57) ABSTRACT

Many factors contribute to the final predictive accuracy of a trained machine learning model, but the model's predictive behavior depends unavoidably on each of the samples used to train it. After a model is trained, some of the training samples may be found later to be undesired. Undesired samples could represent personal information of a consumer who has asked to be “forgotten”, incorrectly measured or low-quality input data, irrelevant data used to train a base model later used in transfer learning, or samples found to be unwanted for any other reason. Heretofore, the only technique available to remove the effect of undesired samples was to retrain the model with those samples removed from the training set. This invention provides a method to remove the effect of undesired samples after the model is trained, without the need to retrain the entire model from scratch.

### REFERENCE TO RELATED APPLICATIONS

None

### TECHNICAL FIELD OF THE INVENTION

Embodiments of the invention relate generally to systems that use machine learning techniques in order to construct arbitrarily accurate approximations of a mathematically smooth transfer function mapping input data to output results. The field of operation of such models is diverse and ever expanding. The importance of the invention described here is that embodiments, regardless of field of operation, are able to alter an existing, already-trained mapping function in order to reduce or even eliminate the influence (“knowledge”) of specific subsets of training data.

### BACKGROUND OF THE INVENTION

Adoption of Machine Learning (ML) techniques and technologies has expanded dramatically over the past decade, with applications appearing in areas as diverse as financial services, employee recruiting, medical image analysis, autonomous driving, customer service and more. A central tenet of ML is that a computer system can be programmed or “trained” by applying a selected learning algorithm to a set of training data, resulting in a trained ML model. The trained ML model, in turn, is then able (to within a desired statistical limit) to generate desired outputs based on inputs that have not before been seen. ML stands in contrast to the heretofore traditional approach of programming a computer system with explicit logical instructions, the set of which is designed generate desired outputs based on inputs which likewise have not before been seen.

In part, the allure of ML techniques lies in the ability of ML systems to learn the equivalent of a complex set of rules simply by training the algorithm on data, instead of requiring humans to anticipate all possible events and develop explicit rules to properly deal with those events. The availability of open source software supporting the easy construction of ML models, combined with cheap data storage and processing, makes it possible for parties from large organizations all the way down to individuals to create and use ML models.

Successful creation of ML models depends on training the model on a large enough, relevant data set. For optimal training results, the data set often must be carefully prepared. For example, is it common to normalize different numerical data elements to lie within a specific range such as −1.0 to +1.0. Written text may be prepared by creating a dictionary, encoding characters, words, phrases or other constructs into numerical values that can be processed by the learning algorithms. Furthermore, successful training often depends on a suitable quantity of data being available, with common practice being to try to obtain as much data as possible, train the model, and analyze its trained behavior.

ML models are essentially represented by compilations of mathematical functions, the definitions of which are adjusted by applying the model to input data and running a pre-defined process on specific, foundational coefficients of the underlying functions. For example, in supervised training, the ML model to be trained is applied to an input data sample and the output of the model is compared to a known, desired output (a “label”) for that input sample. The coefficients or weights of the terms of the underlying mathematical functions are adjusted to attempt to minimize the difference between the model's output and the desired output. This process is repeated over the entire set of training data (and, in fact, may be repeated multiple times over that set).

In practice, ML models may be trained all at once, by preparing a data set and training the model, or they may be trained over time, with the model observing and learning from a stream of data. It is also common to train a ML model on an initial set of data as a starting point, and then to continue training the model by exposing it to a subsequent stream of data. This is frequently the method used to develop ML models used to act upon interactions with consumers: ML models that customize a web site experience to each user are often prepared and maintained this way.

Typically, ML models that provide significant value take time and care to train. In addition, models that are intended to be placed into operation making sensitive decisions (for example, creditworthiness decisions) must be validated to ensure that they operate within limits that are acceptable to the owning organization, acceptable to regulators, and compliant with applicable laws. It can be expensive in terms of human effort (and even processing costs) to retrain and re-validate a model from scratch. This fact leads to the reuse of basic pre-trained models that are further trained for a specific application by a process known as transfer learning. In transfer learning, the baseline pre-trained model is taken as-is as a starting point; it has been trained on “stock data”—data that is similar to, but not the same as, the data to be used in the actual decision process.

The desired ML model required for the application at hand is obtained by starting with the pre-trained model and running normal training procedures on it using problem-specific training data. This can significantly reduce the cost and time to train a ML model to the desired level of precision and accuracy.

In the current state of the art, techniques such as federated learning are used to combine the effects of learned models trained on subsets of a larger data set. These techniques can be used to preserve privacy (because training data does not have to be shared) and to distribute the training efforts across many independent systems, such as disclosed in McMahan et al. U.S. Pat. No. 10,657,461 B2, May 19, 2020.

In some cases, the trained models are combined in a manner that is superficially reminiscent of the approach here (e.g.—algebraically), but there are key differences. Specifically, in none of these approaches is the combination based upon a model that is trained on the data to be suppressed, which model is then combined with the master model to yield the desired final model.

Ensemble techniques are used to adjust the output of one machine learning model to incorporate the output of a different model. For example, multiple classifier models may be combined with a simple or a weighted average in order to improve the prediction accuracy, as disclosed in Izmailov, Pavel et al, Averaging Weights Leads to Wider Optima and Better Generalization, arXiv:1803.05407v3, Feb. 25, 2019.

In this case, however, the combination is done at the output point—multiple models are run, and the output of each is incorporated into the ensemble output. This is very different from the approach of this invention, since the invention presented here actually adjusts the base model itself in order to accommodate (after the fact) the desired adjustment to the training data.

More recently, techniques have been developed that create ensembles from a particular network in different stages of training. This is known as an ensemble “in weight space” and is an important advance, because it can reduce the training time required and can improve output accuracy, as disclosed in Pechyonkin, Max, Stochastic Weight Averaging—a New Way to Get State of the Art Results in Deep Learning, Towards Data Science, (https://towardsdatascience.com/stochastic-weight-averaging-a-new-way-to-get-state-of-the-art-results-in-deep-learning-c639ccf36a, accessed Jun. 17, 2020)

Significantly, though, this technique is being applied to the full training data set and is being used to create a final model; it has not been used to create a model that removes the effects of undesired data. In particular, the most promising of the weight-space techniques, stochastic weight averaging, performs a pseudo-random averaging across multiple states of the main weight set during training. This can never approximate the subtle yet very organized change in model weights as described in this invention.

The power of ML together with the ease of obtaining ML development tools and the financial efficiency of handling and processing large sets of data has led to the aforementioned proliferation of use of ML techniques. Despite the advances in ML techniques, inherent in this expansion is a fundamental issue that to this point has not been well addressed.

Specifically, once a ML model has been trained, there has been no effective technique for removing or mitigating the training effects of input training data samples that are later determined to be undesired. The invention described herein provides such a capability.

### BRIEF DESCRIPTION OF THE DRAWING FIGURES

FIG. 1. is a diagram of a smooth function F and the first-term Taylor series approximation of that function.

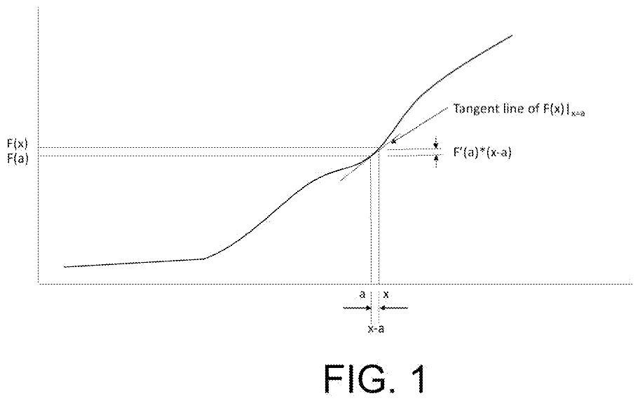

### DETAILED DESCRIPTION

### Definitions

In order to support the discussion below, we define here a few terms.
a. Desired Training Data (DTrD): the set of training data samples that are ultimately determined to be desirable.
b. Desired Test Data (DTeD): the set of test data samples that are ultimately determined to be desirable.
c. Undesired Training Data (UTrD): the set of training data samples that are ultimately determined to be undesirable or to be removed, and whose effect is to be minimized or removed from the final model.
d. Undesired Test Data (UTeD): the set of test data samples that are ultimately determined to be undesirable or to be removed, as with the UTrD.
e. Full Training Data (FTrD): the set of training data that contains both the DTrD and the UTrD.
f. Full Training Data (FTeD): the set of test data that contains both the DTeD and the UTeD.
g. Master Model: a ML model trained on the FTrD
h. Expunged Model: a ML model created by adjusting the Master Model according to this invention in order to reduce or remove the effect of the UTrD.
i. Updated Model: a ML model created by additional training of the Expunged Model on data that does not include undesirable data. This may be trained with some or all of the DTrD, or it may be trained with new data that contains desirable data samples.

Embodiments of the invention allow a trained machine learning model to be adjusted after training in such a way that the adjusted model behaves arbitrarily closely to the same type of model trained on a training data set that excludes a specific subset of the original training data.

In an example embodiment, a three-layer fully connected neural network (NN₁) is constructed of a set of n input nodes, a hidden layer consisting of h nodes, and an output layer consisting of c nodes. NN₁ may be instantiated by software running on a suitable computer processor or a graphical processing unit (GPU), modeling the NN₁ as a pair of two-dimensional matrices θ₁ and θ₂. The matrix θ₁ describes the mathematical operation that maps the n components of input data sample Xᵢ onto the h hidden nodes of the hidden layer. An activation function, A₁, is applied to the result of this mapping at each of the h hidden nodes, yielding a description of the activation of each of the h hidden nodes for input Xᵢ. The activation state of each of the h hidden nodes is then mapped to the c output nodes by the matrix θ₂. A second activation function A₂ is then applied to the result of this second mapping, yielding a description of the activation of each of the c output nodes for input Xᵢ. Finally, the output node with the highest activation state may be selected by a maximum function M and taken as the “output” of the NN₁ when applied to Xᵢ.

The matrices θ₁ and θ₂ are adjusted mathematically in order to train the NN₁. For example, θ₁, A₁, θ₂, A₂ and M may be applied to a training data sample Xᵢ. The output, Cᵢ, resulting from this process is then compared to the known “true” result (the “label”), Lᵢ, that the NN₁ should present if properly trained. An algorithm T is then applied to the elements that comprise Oland θ₂ to adjust those elements in such a way as to reduce the difference between Lᵢ and Cᵢ. Examples of the algorithm T include gradient descent, gradient descent with back propagation, Broyden-Fletcher-Goldfarb-Shanno (BFGS) algorithm and others. It is important to note that this invention is not dependent upon the specific algorithm T.

This sample embodiment can be used, for example, for character recognition, wherein the input nodes correspond to n image pixels, θ₁ is a (n×h) matrix that maps from the n input pixels to the h hidden nodes, and θ₂ is a (h×c) matrix that maps from the h hidden nodes to the c output nodes. A₁ and A₂ may be, for example, sigmoid activation functions, with M being a function that returns an indication of which of the c output nodes presents the maximum value. Mathematically, the application of NN₁ to sample Xᵢ to yield output Cᵢ can be written as:

C₁=M(A₂(θ₂×A₁(θ₁×Xᵢ)))

or

C₁=NN₁(Xᵢ)

(Here, x denotes matrix multiplication).

In a typical embodiment, training will begin with an initial, randomized pair of matrices θ₁ and θ₂, forming an untrained version of NN₁ which we denote NN₁₍ᵤ₎. The algorithm T is then applied sequentially over the set of training data. T will adjust the elements of θ₁ and θ₂, but will not change the activation functions A₁ and A₂, nor will it change the selection function M. More concretely, in a typical embodiment, the ML model is “trained” by using a computer or GPU to evaluate error terms

Eᵢ=Lᵢ−Cᵢ

and then to apply T to adjust the elements of θ₁ and θ₂ to minimize this error Eᵢ, sequentially for all samples in the training data set.

At the end of training, the trained ML model, which we denote here by NN₁₍ₜ₎, represents a complicated function F(Θ, X) that depends upon the trained matrices (here represented together as Θ) and maps the Xᵢ elements of the training data to the Lᵢ desired output values with a measurable accuracy α, defined as

$$α = \frac{{N}_{correct}}{{N}_{total}}$$

Here, N_{correct} is the calculated number of outputs where Cᵢ=Lᵢ and Nₜₒₜₐₗ is the total number of samples evaluated. For example, a trained ML model that is evaluated against 1000 (Nₜₒₜₐₗ=1000) samples Xᵢ (with associated known correct values Lᵢ) that yields 952 correct answers (N_{correct}=952; that is, in 952 cases, the calculated Cᵢ equals the known Lᵢ), has an accuracy of 95.2%.

The accuracy α of the model may be calculated against different data sets. For example, it is often instructive to understand the accuracy of the trained model against the training data itself; against test data which is from the same batch of data as the training data, but which has been held aside and not used to train the model; and against unseen data, which is new data that is neither from the training set nor from the test set.

A central tenet of machine learning is that the training process depends upon making a sequence of small changes to the coefficients or weights used to map the input samples to the output values to arrive at the final (trained) mapping function F(Θ, x). This assumption implies that F(Θ, x) is a smooth function of the coefficients being trained (represented by Θ): that it is continuous and differentiable in each of the coefficients comprising Θ.

Said differently, the change in these coefficients that constitute Θ is taken to be small as a result of training a model against one input training sample of a large set of such samples; this is characteristic of well-designed machine learning processes. This change may be expressed as:

δₘᵢⱼ^{n,n+1}=θₘᵢⱼⁿ⁺¹−θₘᵢⱼⁿ

where m denotes the matrix (in a typical three layer neural network, for example, m would equal 1 or 2); i and j denote the individual element of that θₘ matrix; n denotes a sample in the training data set and n+1 denotes the next sample in the training data set.

By our definition of δₘᵢⱼ^{n,n+1}, the effect on a model of training against data sample n+1 is to change the coefficients thus:

θₘᵢⱼⁿ⁺¹=θₘᵢⱼⁿ+δₘᵢⱼ^{n,n+1}

If we were to train the model on sample n+1, we should immediately be able to “untrain” it and return to θₘᵢⱼⁿ by simple subtraction:

θₘᵢⱼⁿ=θₘᵢⱼⁿ⁺¹−δₘᵢⱼ^{n,n+1}.

To a first approximation, then, the effect on the trained model of not training it with sample n+1 may be found by subtracting δₘᵢⱼ^{n,n+1} from the coefficient θₘᵢⱼ of the fully-trained model. (In fact, building on the assumption that F(Θ, x) is smooth over Θ, we understand that a Taylor series expansion in Θ may be used to approximate the effect of small changes to the coefficients that comprise Θ.)

For the purposes of describing this invention, we now refer back to the data definitions above. The DTrD consists of the set of training data that ultimately should be retained, while the UTrD consists of the set of training data that, after model training, is determined to be undesired. For example, the UTrD might be comprised of the data that represents a user who had demanded to be forgotten; or, it may be comprised of the data that is found to be “poor data samples” as described in Example 2 above.

In an example embodiment of this invention, a computer or GPU (the “processor”) is loaded with executable software that implements a three-layer neural network training capability as described above. The processor is further supplied with training data consisting of the FTrD, the full training data set. Following a defined algorithm, the model is trained on the FTrD, resulting in a trained model which we will call the Master Model, MM₁. Subsequent to the completion of training, the FTrD is discovered to contain data (UTrD) the influence of which should no longer be allowed to affect the behavior of the model.

In this sample embodiment, the following steps are now taken:

UTrD is divided into B subsets or “batches”.

MM₁ is further trained on each of these batches of the UTrD, one batch at a time.

At the completion of training on the k^{th} batch, a new intermediate model IM₁ₖ results, where k denotes the index of the batch.

In the same manner as in the description above of the example embodiment designated as NN₁, which contains matrices θ₁ and θ₂, IM₁ₖ is composed of a pair of two-dimensional matrices θ₁ₖ and θ₂ₖ, the elements of which have now been adjusted by algorithm T to reflect the training on batch k of UTrD.

The element-wise difference between θ₁ₖ and θ₁ is taken; we call this difference δ₁ₖ and it is understood that δ₁ₖ=θ₁ₖ−θ₁. The element-wise difference between θ₂ and θ₂ₖ is taken as well; we call this δ₂ₖ and it is similarly understood that δ₂ₖ=θ₂ₖ−θ₂.

The averages of all δ₁ₖ and δ₂ₖ are computed as

$${Δ}_{1} = \frac{1}{B} {\sum }_{k = 0}^{B - 1} {δ}_{1 k}$$

a. and

$${Δ}_{2} = \frac{1}{B} {\sum }_{k = 0}^{B - 1} {δ}_{2 k}$$

Two new matrices, θ_{E1} and θ_{E2} are computed as

b. θ_{E1}=θ₁−Δ₁

c. and

d. θ_{E2}=θ₂−Δ₂

These new matrices are used to construct the Expunged Model, EM₁, in which the effects of UTrD have been mitigated. (The matrices θ_{E1} and θ_{E2} fill the same roles in EM₁ as do θ₁ and θ₂ in NN₁ or MM₁.)

Since the elements of the matrices of EM₁ now differ from the corresponding elements of the matrices of MM₁, the fully-trained Master Model, the behavior of EM₁ against input data will, by design, differ from the behavior of MM₁. If the accuracy α_{E} of EM₁ applied to DTrD (for example) is lower than desired, EM₁ may be retrained on some of all of DTrD to create UM₁, an Updated Model. Note that this step is optional. The amount of training required, if any, can be determined by monitoring a during training of the Updated Model.

The reduced effect of UTrD displayed by EM₁ can be demonstrated by evaluating the accuracy of EM₁ against UTrD or UTeD. The accuracy of a properly-prepared EM₁ will be much lower against the undesired data than will be the accuracy of the Master Model, MM₁. Similarly, if it is desired to create UM₁, the accuracy of UM₁ can be tested against UTrD or UTeD; the accuracy of UM₁ against the undesired data will also be much lower than will be the accuracy of the Master Model, MM₁ against the same data.

An interesting example embodiment augments the above steps such that a Test Expunged Matrix TEM₁ is computed after some subset of the UTrD batches has been processed (even after each single batch). The accuracy of TEM₁ is then computed against a chosen data set (for example, the UTeD) and the further training is stopped when such computed accuracy reaches a desired level.

Consider the following example situations and illustrative embodiments. Three examples illustrate typical applications of this invention to real-world problems. These should in no way be considered the limits of applicability; they are instead intended to be simple, easy to follow cases in which this invention can be applied to achieve an important desired outcome.

Example 1, the Right to be Forgotten. Both in the European Union and in States such as California, new laws are explicitly giving consumers a “right to be forgotten” by services the consumers use. Typically, this is envisioned as a user of a digital on-line service who desires to terminate a relationship with that service and who notifies the service to remove his or her data and fully “forget” him or her. While the operation of removing stored data (including backups, copies, and so on) is itself problematic and difficult, the concept of “forgetting” a person whose data has been used in training a ML model is even more difficult.

The problem is that the model needs to be modified so that it behaves as if it had been trained on the training data it has seen, except for the data of the user who has demanded to be forgotten. The obvious options are to 1) leave the model as-is or 2) retrain the model from scratch, with the to-be-forgotten user's data removed from the training set. The first option is undesirable since it explicitly ignores the consumer's demand to be forgotten. This may subject the operating entity—the organization running the model—to legal and regulatory challenges. The second option also is often undesirable as the training and validation process takes time and can be expensive. The legal and social exposure resulting from ignoring requests to be forgotten or the costs and time delays of training models anew from scratch will multiply as more requests to be forgotten are received. A way to cause a trained model to “forget” a user is required.

Example 2: correcting for bad data. As noted above, a common approach to training ML models is to collect as much data as possible, pre-process the data in order to make it easier to use it to train a model, then train and validate the model. Occasionally, this drive to obtain and train on ever-larger collections of data leads to training models on data that contains samples that are of dubious quality. Similarly, data collection processes may be found to be inadequate after a model is trained on that data. Once a model has been trained, the effects of the poor data samples are embedded in the coefficients or weights of the model and, ultimately, can lead to incorrect operation of the model.

As in Example 1, the options are to ignore the problem or to retrain the model from scratch with the offending data removed from the training set. Ignoring the problem exposes the model operator to the risk that the model will perform incorrectly on as-yet unseen data in the future. Retraining from scratch, as described before, can be cost prohibitive. A way to minimize the effect on a trained model of undesired training data is required.

Example 3: achieving more effective transfer learning by reducing the effect of undesired or irrelevant stock training data. When a pre-trained ML model is used as the starting point for a transfer-learning process, the pre-trained model is trained on data that should be similar to, but is by definition not identical to, data describing the problem to which the model is to be applied. Evolving the pre-trained model into a finished model that performs at the desired level is more expensive (in terms of time, money and human effort) the more the stock training data differs from the real data. If particular classes or samples of the stock data differ more strongly from the actual data, it can be desirable to reduce the effect of those undesirable stock data samples on the pre-trained model before that model is trained in transfer learning. Two of the three options in this case are similar to those in the previous two examples: 1) the problem can be ignored and the pre-trained model can be used as is; 2) the pre-trained model can be deemed unusable, requiring a different baseline pre-trained model to be found, or requiring transfer learning to be abandoned and a bespoke model to be trained from scratch; or 3) an attempt may be made to drown-out the effect of the irrelevant data by training on an enormous set of new learning data. In case 1, the model behavior may be poor on as-yet unseen data. In case 2, the cost and time to find and validate a different baseline model can well be prohibitive, as can the cost and time (and perhaps expertise required) to train a bespoke model may make this choice untenable. In case 3, achieving appropriate behavior may require a much larger amount of transfer-learning data as well as an excessive amount of time and cost to train.

An efficient way to reduce the impact of specific classes or sets of training data on a resulting trained model is required.

What is claimed is:

1. A method of modifying an original trained machine learning model into a modified trained model, the method comprising:
identifying a subset of the training data consisting of samples the influence of which on the modified model is no longer desired; and
incrementally further training, using samples of the no-longer-desired data, the original trained model into an intermediate trained model; and
constructing a representation of the difference between the coefficients of the intermediate trained model and the coefficients of the original trained model; and
calculating a modified trained model by modifying the original trained model by applying to the coefficients of the original trained model a transformation function that depends on the difference between the coefficients of the intermediate trained model and the coefficients of the original trained model.

2. The method of claim 1, wherein said further training is accomplished by:
applying batched subsets of the no-longer-desired data; and
calculating the difference between the coefficients of the intermediate trained model and the original trained model after each batch is applied individually; and
computing the average over all batches of the difference per coefficient; and
calculating a modified trained model by modifying the original trained model by applying to the coefficients of the original trained model a transformation function that depends on such averaged difference.

3. The method of claim 1 wherein the transformation function is an element-wise subtraction of the differences from the coefficients of the original trained model.

4. The method of claim 2 wherein the transformation function is an element-wise subtraction of the averaged differences from the coefficients of the original trained model.

5. The method of claim 2 wherein a test model is created after some portion of the no longer-desired data has been used for the further training of the original trained model; such test model is computed by modifying the original trained model by applying to the coefficients of the original trained model a transformation function that depends on the difference between the coefficients of the intermediate trained model and the original trained model; the accuracy of the test model is evaluated against one or more chosen sets of data samples; the further training of the original trained model is halted when such computed accuracy reaches a desired value.

6. The method of claim 2 wherein the transformation function is expressed as aN approximation of a polynomial series expansion in the coefficients of the model and the expansion series term coefficients are calculated analytically by taking the partial derivatives of the transformation function with respect to the coefficients of the model.

7. The method of claim 6 wherein the transformation function is expressed as an approximation of a polynomial series expansion in the coefficients of the model and the expansion series term coefficients are calculated by numerically approximating the partial derivatives of the transformation function with respect to the coefficients of the model.

8. The method of claim 6 in which the polynomial expansion is a Taylor series expansion.

9. The method of claim 7 in which the polynomial expansion is a Taylor series expansion.

10. The method of claim 2 wherein the intermediate model is created in stages, by training on batches of data and calculating approximate models after each training batch.

11. The method of claim 2, wherein multiple intermediate models are created simultaneously by training on the same batch of data, and such multiple models are combined to yield a single intermediate model.

12. A machine learning system comprising:
a computing device programmed to receive from a data storage device a sequence of training data samples; and
the computing device further programmed to implement a machine learning algorithm that will train a machine learning model by sequentially operating on such training data samples and adjusting the elements of the machine learning model in response to those training data samples; and
the computing device further programmed to allow designation of some training data samples as training data samples to be no longer desired; and
the computing device further programmed to allow additional training of a trained machine learning model, such training using some or all of the data samples designated as no longer desired; and
the computing device further programmed to calculate a representation of a difference between the trained machine learning model and the further-trained machine learning model; and
the computing device further programmed to apply a transformation function to the trained machine learning model, such transformation function being at least in part based on such calculated representation of a difference between the trained machine learning model and the further-trained machine learning model; and
a data storage device containing the training data samples.

13. The system of claim 12 wherein the computing device is a general-purpose computing device.

14. The system of claim 12 wherein at least a portion of the computing device is a cloud-based computing device.

15. The system of claim 12 wherein at least a portion of the computing device is a GPU.

16. A non-transitory computer readable medium encoded with computer executable instructions comprising instructions for:
receiving from a data storage device a sequence of training data samples; and
implementing a machine learning algorithm that will train a machine learning model by sequentially operating on such training data samples and adjusting the elements of the machine learning model in response to those training data samples; and
allowing designation of some training data samples as training data samples no longer to be desired; and
allowing additional training of a trained machine learning model, such training using some or all of the data samples designated as no longer desired; and
calculating a representation of a difference between the trained machine learning model and the further-trained machine learning model; and
applying a transformation function to the trained machine learning model, such transformation function being at least in part based on such calculated representation of a difference between the trained machine learning model and the further-trained machine learning model.
